(19) United States
(12) Patent Application Publication
(10) Pub. No.: US 2024/0333562 A1
(43) Pub. Date: Oct. 3, 2024

(54) COMMUNICATION SYSTEM, PROCESSING METHOD, AND NON-TRANSITORY COMPUTER-READABLE STORAGE MEDIUM

(71) Applicant: NEC CORPORATION, Tokyo (JP)

(72) Inventor: Osamu HASEGAWA, Tokyo (JP)

(73) Assignee: NEC CORPORATION, Tokyo (JP)

(21) Appl. No.: 18/600,938

(22) Filed: Mar. 11, 2024

(30) Foreign Application Priority Data
Mar. 29, 2023 (JP) 2023-052891

(51) Int. Cl. H04L 25/06; H04L 1/00; H04L 25/03

(52) U.S. Cl. CPC H04L 25/061; H04L 1/0042; H04L 25/03006; H04L 2025/03808

(57) ABSTRACT

A communication system provided with first generator for generating an error signal based on an ideal signal generated based on an output signal from a decider for performing a hard decision, and an input signal to the decider; second generator for generating a compensation coefficient for compensating for non-linear distortion included in a modulation signal, which is a transmission signal, based on the error signal; and compensator for compensating for the non-linear distortion based on the compensation coefficient.

This application is based upon and claims the benefit of priority from Japanese patent application No. 2023-052891, filed Mar. 29, 2023, the disclose of which is incorporated herein in its entirety by reference.

### TECHNICAL FIELD

The present disclosure relates to a communication system, a processing method, and a non-transitory computer-readable storage medium.

### BACKGROUND ART

Communication technology is used in various fields. Patent Document 1 ((Japanese Unexamined Patent Application Publication No. 2011-160043) discloses, as related technology, technology pertaining to an apparatus that can compensate for distortion in transmission signals.

### SUMMARY

The embodiments disclosed herein have, as an example of an objective thereof, to provide a communication system, a processing method, and a non-transitory computer-readable storage medium.

In order to achieve the above-mentioned objective, according to one example of an aspect disclosed herein, a communication system is provided with first generator for generating an error signal based on an ideal signal generated based on an output signal from a decider for performing a hard decision, and an input signal to the decider; second generator for generating a compensation coefficient for compensating for non-linear distortion included in a modulation signal, which is a transmission signal, based on the error signal; and compensator for compensating for the non-linear distortion based on the compensation coefficient.

In order to achieve the above-mentioned objective, according to one example of another aspect disclosed herein, a processing method involves generating an error signal based on an ideal signal generated based on an output signal from a decider for performing a hard decision, and an input signal to the decider; generating a compensation coefficient for compensating for non-linear distortion included in a modulation signal, which is a transmission signal, based on the error signal; and compensating for the non-linear distortion based on the compensation coefficient.

In order to achieve the above-mentioned objective, according to one example of another aspect disclosed herein, a non-transitory computer-readable storage medium that stores a program makes a computer execute a process of generating an error signal based on an ideal signal generated based on an output signal from a decider for performing a hard decision, and an input signal to the decider; generating a compensation coefficient for compensating for non-linear distortion included in a modulation signal, which is a transmission signal, based on the error signal; and compensating for the non-linear distortion based on the compensation coefficient.

### BRIEF DESCRIPTION OF THE DRAWINGS

FIG. 1 is a diagram illustrating an example of the configuration of a communication system according to a first embodiment of the present disclosure.

FIG. 2 is a diagram illustrating an example of the configuration of a digital pre-distortion compensation unit according to a first embodiment of the present disclosure.

FIG. 3 is a diagram indicating an example of a complex plane in the first embodiment of the present disclosure.

FIGS. 4A to 4E are diagrams indicating an example of the frequency band of the main signal in a communication system according to the first embodiment of the present disclosure.

FIG. 5 is a diagram indicating an example of the processing flow in a communication system according to the first embodiment of the present disclosure.

FIG. 6 is a diagram illustrating an example of the configuration of a communication system according to a second embodiment of the present disclosure.

FIG. 7 is a diagram illustrating an example of the configuration of a counterpart station apparatus according to the second embodiment of the present disclosure.

FIG. 8 is a diagram illustrating an example of the configuration of a communication system according to a modified example of the second embodiment of the present disclosure.

FIG. 9 is a diagram illustrating an example of the configuration of a counterpart station apparatus according to a modified example of the second embodiment of the present disclosure.

FIG. 10 is a diagram illustrating an example of the configuration of a communication system according to a third embodiment of the present disclosure.

FIG. 11 is a diagram illustrating an example of the configuration of a coefficient updating unit according to modified examples of the first to third embodiments (including modified examples) of the present disclosure.

FIGS. 12A to 12G are diagrams for explaining the processing in a coefficient updating unit according to modified examples of the first to third embodiments (including modified examples) of the present disclosure.

FIG. 13 is a diagram illustrating the minimum configuration of a communication system according to an embodiment of the present disclosure.

FIG. 14 is a diagram indicating an example of the processing flow in the communication system with the minimum configuration according to an embodiment of the present disclosure.

FIG. 15 is a schematic block diagram illustrating the configuration of a computer according to at least one embodiment.

### EXAMPLE EMBODIMENT

Hereinafter, embodiments will be explained in detail with reference to the drawings. The unidirectional arrows on some drawings are a straightforward indication of the direction of flow of certain signals (data) and do not exclude bi-directionality.

### <First Embodiment>

### (Configuration of Communication System)

A communication system 1 according to a first embodiment of the present disclosure will be explained with reference to the drawings. This system compensates for non-linear distortion that occurs in a local station apparatus 1a to be described below based on hard decision error.

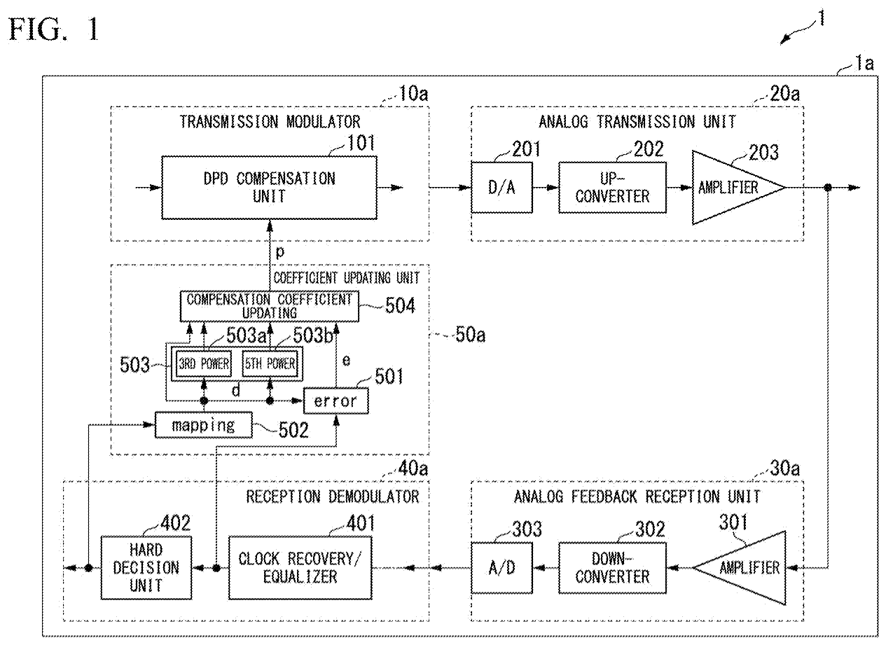

FIG. 1 is a diagram illustrating an example of the configuration of the communication system 1 according to the first embodiment of the present disclosure. The communication system 1 is provided with a local station apparatus 1a as illustrated in FIG. 1.

The local station apparatus 1a, as illustrated in FIG. 1, is provided with a transmission modulator 10a, an analog transmission unit 20a, an analog feedback reception unit 30a, a reception demodulator 40a, and a coefficient updating unit 50a.

The transmission modulator 10a compensates for non-linear distortion that mainly occurs due to an amplifier 203, to be described below, in the local station apparatus 1a. The transmission modulator 10a, as illustrated in FIG. 1, is provided with a digital pre-distortion compensation unit (hereinafter referred to as a “DPD compensation unit”) 101.

The DPD compensation unit 101 compensates for non-linear distortion by using pre-distortion technology in which transmission signals are provided with characteristics that cancel out non-linear distortion (hereinafter referred to as “inverse characteristics”). For example, the DPD compensation unit 101 receives a modulation signal that is a digital signal generated in the transmission modulator 10a. The DPD compensation unit 101 provides the modulation signal with the inverse characteristics for cancelling out non-linear distortion occurring in the local station apparatus 1a based on compensation coefficients p received from the coefficient updating unit 50a. The modulation signal is a signal expressed with complex numbers.

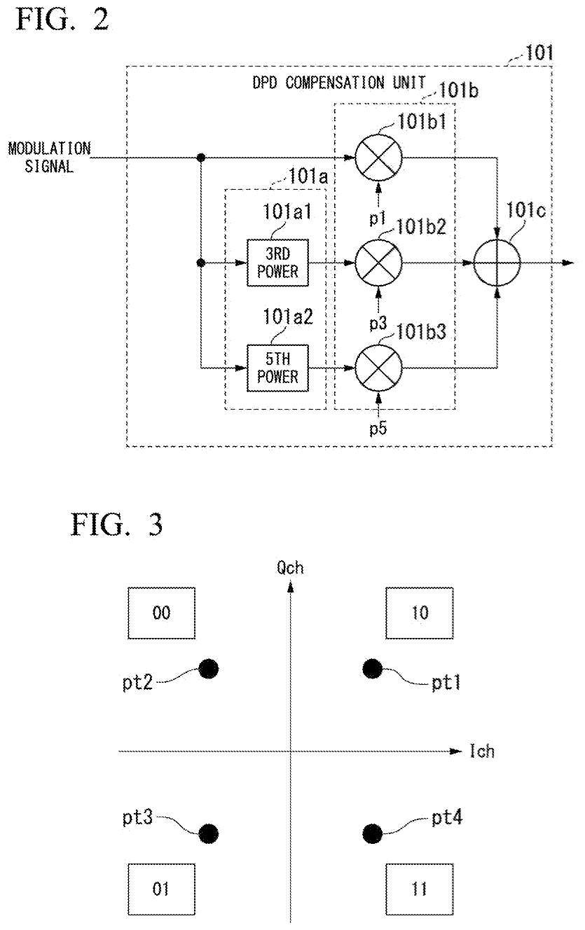

FIG. 2 is a diagram illustrating an example of the configuration of a DPD compensation unit 101 according to a first embodiment of the present disclosure. As indicated in FIG. 2, the DPD compensation unit 101 is provided with a harmonic calculation unit 101a, a multiplication unit 101b, and a combining unit 101c. FIG. 2 illustrates the configuration of the DPD compensation unit 101 when compensating for a third-order harmonic and a fifth-order harmonic of a transmission signal.

The harmonic calculation unit 101a, as indicated in FIG. 2, is provided with a first calculation unit 101al and a second calculation unit 101a2.

The first calculation unit 101al receives the modulation signal. The first calculation unit 101al calculates the third power of the received modulation signal, thereby calculating the third-order harmonic of the modulation signal. The first calculation unit 101al outputs the calculated third-order harmonic to the multiplication unit 101b.

The second calculation unit 101a2 receives the modulation signal. The second calculation unit 101a2 calculates the fifth power of the received modulation signal, thereby calculating the fifth-order harmonic of the modulation signal. The second calculation unit 101a2 outputs the calculated fifth-order harmonic to the multiplication unit 101b.

The multiplication unit 101b, as illustrated in FIG. 2, is provided with a first multiplication unit 101b1, a second multiplication unit 101b2, and a third multiplication unit 101b3.

The first multiplication unit 101b1 receives the modulation signal generated in the transmission modulator 10a. Additionally, the first multiplication unit 101b1 receives a coefficient p1 for compensating for the modulation signal, the coefficient p1 being one of the compensation coefficients p, from the coefficient updating unit 50a. The coefficient p1 will be explained in detail below. Then, the first multiplication unit 101b1 multiplies the transmission signal with the coefficient p1. The first multiplication unit 101b1 outputs the multiplication result to the combining unit 101c.

The second multiplication unit 101b2 receives the third-order harmonic from the first calculation unit 101a1. Additionally, the second multiplication unit 101b2 receives a coefficient p3 for the third-order harmonic, the coefficient p3 being one of the compensation coefficients p, from the coefficient updating unit 50a. The coefficient p3 will be explained in detail below. Then, the second multiplication unit 101b2 multiplies the third-order harmonic with the coefficient p3. The second multiplication unit 101b2 outputs the multiplication result to the combining unit 101c.

The third multiplication unit 101b3 receives the fifth-order harmonic from the second calculation unit 101a2. Additionally, the third multiplication unit 101b3 receives a coefficient p5 for the fifth-order harmonic, the coefficient p5 being one of the compensation coefficients p, from the coefficient updating unit 50a. The coefficient p5 will be explained in detail below. Then, the third multiplication unit 101b3 multiplies the fifth-order harmonic with the coefficient p5. The third multiplication unit 101b3 outputs the multiplication result to the combining unit 101c.

The combining unit 101c receives the multiplication results from each of the first multiplication unit 101b1, the second multiplication unit 101b2, and the third multiplication unit 101b3. The combining unit 101c combines the three multiplication results that have been received. The combination result of this combining by the combining unit 101c is a modulation signal provided with inverse characteristics. The combining unit 101c outputs the combination result to the analog transmission unit 20a.

The analog transmission unit 20a, as illustrated in FIG. 1, is provided with a D/A (Digital-to-Analog) converter 201, an up-converter 202, and an amplifier 203.

The D/A converter 201 receives the modulation signal from the transmission modulator 10a. The D/A converter 201 converts the received modulation signal to a modulation signal that is an analog signal. The D/A converter 201 outputs the converted modulation signal to the up-converter 202.

The up-converter 202 receives the modulation signal from the D/A converter 201. The modulation signal received by the up-converter 202 is a signal in the BB (Base Band) frequency band. The up-converter 202 converts the frequency band of the modulation signal from BB to RF (Radio Frequency). The up-converter 202 outputs the converted modulation signal to the amplifier 203.

The amplifier 203 receives the modulation signal from the up-converter 202. The amplifier 203 amplifies the received modulation signal. The amplifier 203 outputs, to an outside destination and to the analog feedback reception unit 30a, a transmission signal including the amplified modulation signal and non-linear distortion components thereof. The amplifier 203 is, for example, a power amplifier.

The analog feedback reception unit 30a, as illustrated in FIG. 1, is provided with an amplifier 301, a down-converter 302, and an A/D (Analog-to-Digital) converter 303.

The amplifier 301 receives, as a reception signal, the transmission signal output by the analog transmission unit 20a. The amplifier 301 amplifies the reception signal. The amplifier 301 outputs the amplified reception signal to the down-converter 302.

The down-converter 302 receives the reception signal from the amplifier 301. The reception signal received by the down-converter 302 is a signal in the RF frequency band. The down-converter 302 converts the frequency band of the reception signal from RF to BB. The down-converter 302 outputs the converted reception signal to the A/D converter 303.

The A/D converter 303 receives the reception signal from the down-converter 302. The reception signal received by the A/D converter 303 is an analog signal. The A/D converter 303 converts the received reception signal from an analog signal to a digital signal. The sampling frequency when the A/D converter 303 converts the reception signal from an analog signal to a digital signal is a frequency that is m times the symbol rate, where m is a value equal to or greater than 2. The A/D converter 303 outputs the converted reception signal to the reception demodulator 40a.

The reception demodulator 40a, as illustrated in FIG. 1, is provided with a clock recovery/equalizer 401 and a hard decision unit 402.

The clock recovery/equalizer 401 receives the reception signal from the analog feedback reception unit 30a. The clock recovery/equalizer 401 corrects the frequency characteristics of the received reception signal and synchronizes the modulation signal, which is the reception signal, with a clock signal. Due to the clock recovery/equalizer 401 performing the process of correcting the frequency characteristics of the reception signal and synchronizing the reception signal with a symbol clock, a reception signal that has been oversampled by the A/D converter 303 is converted to a reception signal at the symbol rate. The clock recovery/equalizer 401 corrects the frequency characteristics of the reception signal and outputs the reception signal resulting after having performed the process for synchronizing the modulation signal, which is the reception signal, with the clock signal, to the hard decision unit 402 and the coefficient updating unit 50a.

The hard decision unit 402 receives the reception signal from the clock recovery/equalizer 401. The hard decision unit 402 determines what kind of signal the received reception signal is. FIG. 3 is a diagram indicating an example of the complex plane in the first embodiment of the present disclosure. For example, suppose that a QPSK (Quadrature Phase-Shift Keying) modulation scheme is used, and as indicated in FIG. 3, the bits 10 are allocated to the first quadrant, the bits 00 are allocated to the second quadrant, the bits 01 are allocated to the third quadrant, and the bits 11 are allocated to the fourth quadrant in the complex plane. In this case, the hard decision unit 402 converts the modulation signal, which is the reception signal received from the clock recovery/equalizer 401, to digital bits. Due to this conversion, a hard decision output signal output by the hard decision unit 402 is one of the digital bits 00, 01, 10, and 11. Then, if the modulation signal that is the reception signal received from the clock recovery/equalizer 401 is in the first quadrant, the hard decision unit 402 decides on the bits 10. Additionally, if the modulation signal that is the reception signal received from the clock recovery/equalizer 401 is in the second quadrant, the hard decision unit 402 decides on the bits 00. Additionally, if the modulation signal that is the reception signal received from the clock recovery/equalizer 401 is in the third quadrant, the hard decision unit 402 decides on the bits 01. Additionally, if the modulation signal that is the reception signal received from the clock recovery/equalizer 401 is in the fourth quadrant, the hard decision unit 402 decides on the bits 11. The hard decision unit 402 outputs the decision results to the coefficient updating unit 50a.

The coefficient updating unit 50a generates compensation coefficients p to be used by the transmission modulator 10a when compensating for non-linear distortion that mainly occurs due to the amplifier 203 in the local station apparatus 1a. The coefficient updating unit 50a, as illustrated in FIG. 1, is provided with an error calculation unit 501, a mapping unit 502, a harmonic calculation unit 503, and a compensation coefficient updating unit 504. The coefficient updating unit 50a operates at the symbol rate.

The error calculation unit 501 receives the reception signal from the clock recovery/equalizer 401. Additionally, the error calculation unit 501 receives, from the mapping unit 502, an ideal signal d to be described below. Then, the error calculation unit 501 subtracts the reception signal from the ideal signal d. The error calculation unit 501 outputs the subtraction result, as an error signal e, to the compensation coefficient updating unit 504. The error signal e is complex.

The mapping unit 502 receives the decision result of the hard decision unit 402 from the reception demodulator 40a. The mapping unit 502 replaces the received decision results with signal points in accordance with a modulation scheme. For example, in the case in which a QPSK modulation scheme is used as the modulation scheme, when a decision result indicating the bits 10 indicating the first quadrant is received, the mapping unit 502 replaces that decision result with a signal point corresponding to the first quadrant (for example, signal point Pt1 indicated in FIG. 3). Additionally, when a decision result indicating the bits 00 indicating the second quadrant is received, the mapping unit 502 replaces that decision result with a signal point corresponding to the second quadrant (for example, signal point Pt2 indicated in FIG. 3). Additionally, when a decision result indicating the bits 01 indicating the third quadrant is received, the mapping unit 502 replaces that decision result with a signal point corresponding to the third quadrant (for example, signal point Pt3 indicated in FIG. 3). Additionally, when a decision result indicating the bits 11 indicating the fourth quadrant is received, the mapping unit 502 replaces that decision result with a signal point corresponding to the fourth quadrant (for example, signal point Pt4 indicated in FIG. 3). The signal points corresponding respectively to the first quadrant to the fourth quadrant correspond to an ideal modulation signal (i.e., a modulation signal including an amplitude and a phase that was actually supposed to be transmitted, hereinafter referred to as “ideal signal d”). For this reason, the mapping unit 502 converts the received reception signal to the ideal signal d by replacing the decision result with signal points corresponding to one of the first quadrant to the fourth quadrant on the complex plane. This ideal signal d is complex. Then, the mapping unit 502 outputs the ideal signal d to the error calculation unit 501, the harmonic calculation unit 503, and the compensation coefficient updating unit 504.

The harmonic calculation unit 503 is provided with a first calculation unit 503a and a second calculation unit 503b. The harmonic calculation unit 503 receives the ideal signal d from the mapping unit 502. The harmonic calculation unit 503 calculates harmonics of the ideal signal d based on the received ideal signal d. For example, the first calculation unit 503a calculates the third harmonic of the ideal signal d by calculating the third power of the ideal signal d. Additionally, for example, the second calculation unit 503b calculates the fifth harmonic of the ideal signal d by calculating the fifth power of the ideal signal d. The first calculation unit 503a and the second calculation unit 503b respectively output the calculated harmonics of the ideal signal d to the compensation coefficient updating unit 504.

The compensation coefficient updating unit 504 receives the ideal signal d from the mapping unit 502. Additionally, the compensation coefficient updating unit 504 receives the harmonics of the ideal signal d from the harmonic calculation unit 503. Additionally, the compensation coefficient updating unit 504 receives the error signal e from the error calculation unit 501. The compensation coefficient updating unit 504 uses an adaptive algorithm, based on the received ideal signal d, the received harmonics of the ideal signal d, and the received error signal e, to generate compensation coefficients p to be used by the transmission modulator 10a when compensating for the non-linear distortion that mainly occurs due to the amplifier 203 in the local station apparatus 1a.

For example, when LMS (Least Mean Square) is used as the adaptive algorithm and the compensation coefficients p are updated for each symbol, the compensation coefficient updating unit 504 generates the coefficient p1 by performing the calculation in Expression (1). Additionally, the compensation coefficient updating unit 504 generates the coefficient p3 by performing the calculation in Expression (2). Additionally, the compensation coefficient updating unit 504 generates the coefficient p5 by performing the calculation in Expression (3).

$$\\ \begin{matrix}[ Mathematical Expression 1 ] & \\ {p}_{1} ( k + 1 ) = {p}_{1} ( k ) + {μ}_{p 1} d ( k ) {e}^{{}_{} *} ( k ) & ( 1 )\end{matrix}$$

$$\\ \begin{matrix}[ Mathematical Expression 2 ] & \\ {p}_{3} ( k + 1 ) = {p}_{3} ( k ) + {μ}_{p 3} {\vert d ( k ) \vert}^{2} d ( k ) {e}^{{}_{} *} ( k ) & ( 2 )\end{matrix}$$

$$\\ \begin{matrix}[ Mathematical Expression 3 ] & \\ {p}_{5} ( k + 1 ) = {p}_{5} ( k ) + {μ}_{p 5} {\vert d ( k ) \vert}^{4} d ( k ) {e}^{{}_{} *} ( k ) & ( 3 )\end{matrix}$$

In this case, k is an integer equal to or greater than 0. μ is a step size corresponding to the coefficient in the subscript. e*is the complex conjugate of the error signal e.

Additionally, for example, when block LMS is used as the adaptive algorithm and the compensation coefficients p are updated for every L symbols, the compensation coefficient updating unit 504 generates the coefficient p1 by performing the calculation in Expression (4). Additionally, the compensation coefficient updating unit 504 generates the coefficient p3 by performing the calculation in Expression (5). Additionally, the compensation coefficient updating unit 504 generates the coefficient p5 by performing the calculation in Expression (6).

$$\\ \begin{matrix}[ Mathematical Expression 4 ] & \\ {p}_{1} ( k + L ) = {p}_{1} ( k ) + {μ}_{p 1} {\sum }_{l = k}^{k + L - 1} d ( l ) {e}^{{}_{} *} ( l ) & ( 4 )\end{matrix}$$

$$\\ \begin{matrix}[ Mathematical Expression 5 ] & \\ {p}_{3} ( k + L ) = {p}_{3} ( k ) + {μ}_{p 3} {\sum }_{l = k}^{k + L - 1} {\vert d ( l ) \vert}^{2} d ( l ) {e}^{{}_{} *} ( l ) & ( 5 )\end{matrix}$$

$$\\ \begin{matrix}[ Mathematical Expression 6 ] & \\ {p}_{5} ( k + L ) = {p}_{5} ( k ) + {μ}_{p 5} {\sum }_{l = k}^{k + L - 1} {\vert d ( l ) \vert}^{4} d ( l ) {e}^{{}_{} *} ( l ) & ( 6 )\end{matrix}$$

In this case, Lis an integer equal to or greater than 2, representing the block length. 1 is an integer from k to k+L-1.

Then, the compensation coefficient updating unit 504 outputs the generated coefficients p1, p3, and p5, as the compensation coefficients p, to the transmission modulator 10a. For example, the compensation coefficient updating unit 504 performs processes using digital pre-distortion technology.

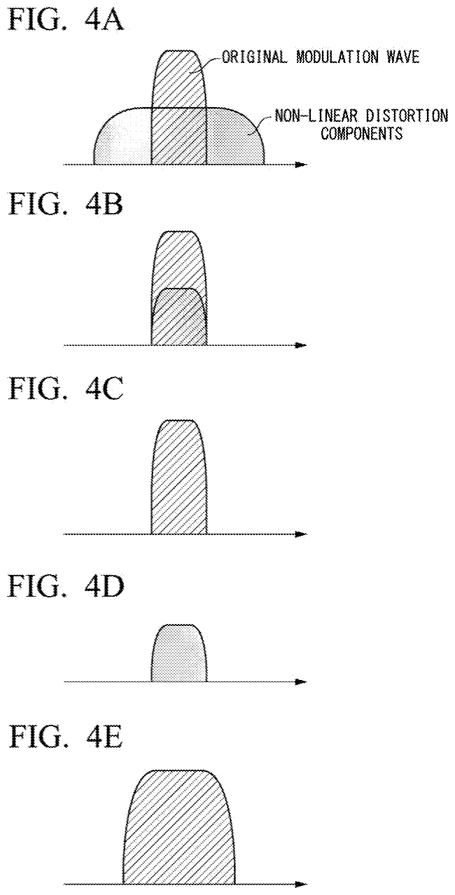

FIG. 4A to FIG. 4E are diagrams indicating an example of the frequency band of a main signal in the communication system 1 according to the first embodiment of the present disclosure. FIG. 4A indicates an image of the frequency band of the output signal from the analog transmission unit 20a. As shown in FIG. 4A, the output signal from the analog transmission unit 20a includes the modulation signal (described as the “original modulation wave” in FIG. 4A) and non-linear distortion components in a wider frequency band than the modulation signal.

FIG. 4B indicates an image of the frequency band of the output signal from the clock recovery/equalizer 401. As indicated in FIG. 4B, the output signal from the clock recovery/equalizer 401 includes the modulation signal and non-linear distortion components in a frequency band of approximately the same width as the modulation signal. FIG. 4C indicates an image of the frequency band of the output signal (i.e., the ideal signal d) from the mapping unit 502. As indicated in FIG. 4C, the output signal from the mapping unit 502 includes the modulation signal (i.e., the ideal signal d).

FIG. 4D indicates an image of the frequency band of the output signal (i.e., the error signal e) from the error calculation unit 501. As indicated in FIG. 4D, the output signal from the error calculation unit 501 includes non-linear distortion components (i.e., the error signal e) in a frequency band of approximately the same width as the modulation signal (i.e., the ideal signal d). FIG. 4E indicates an image of the frequency band of the output signal from the first calculation unit 503a. As indicated in FIG. 4E, the output signal from the first calculation unit 503a includes non-linear distortion components in a frequency band that is three times the width of the non-linear distortion components (i.e., the error signal e) in a frequency band of approximately the same width as the modulation signal (i.e., the ideal signal d).

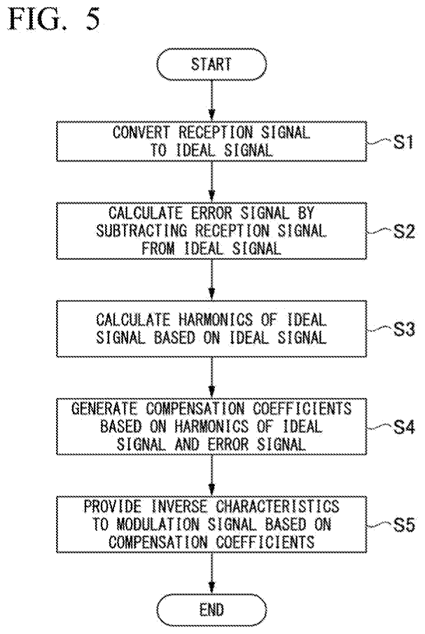

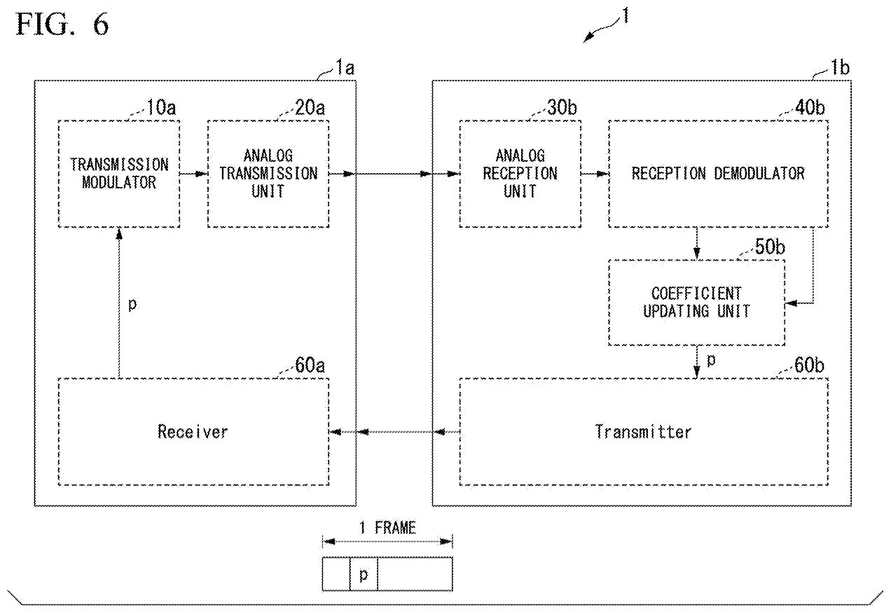

Next, the process performed by the communication system 1 according to the first embodiment of the present disclosure will be explained. FIG. 5 is a diagram indicating an example of the processing flow in the communication system 1 according to the first embodiment of the present disclosure. The process performed by the communication system 1 to compensate for the non-linear distortion components included in the output signal from the analog transmission unit 20a by using the compensation coefficients p will be explained with reference to FIG. 5.

The amplifier 203 outputs a transmission signal including an amplified modulation signal and non-linear distortion components thereof to an outside destination and to the analog feedback reception unit 30a. The amplifier 301 receives, as a reception signal, the transmission signal output by the analog transmission unit 20a. The amplifier 301 amplifies the reception signal. The amplifier 301 outputs the amplified reception signal to the down-converter 302.

The down-converter 302 receives the reception signal from the amplifier 301. The down-converter 302 converts the frequency band of the reception signal from RF to BB. The down-converter 302 outputs the converted reception signal to the A/D converter 303.

The A/D converter 303 receives the reception signal from the down-converter 302. The A/D converter 303 converts the received reception signal from an analog signal to a digital signal. The A/D converter 303 outputs the converted reception signal to the reception demodulator 40a.

The clock recovery/equalizer 401 receives the reception signal from the analog feedback reception unit 30a. The clock recovery/equalizer 401 corrects the frequency characteristics of the received reception signal and synchronizes the modulation signal, which is the reception signal, with a clock signal. The clock recovery/equalizer 401 corrects the frequency characteristics of the reception signal and outputs the reception signal resulting after having performed a process for synchronizing the modulation signal, which is the reception signal, with the clock signal, to the hard decision unit 402 and the coefficient updating unit 50a.

The hard decision unit 402 receives the reception signal from the clock recovery/equalizer 401. The hard decision unit 402 determines what kind of signal the received reception signal is. For example, suppose that a QPSK (Quadrature Phase-Shift Keying) modulation scheme is used, and as indicated in FIG. 3, the bits 10 are allocated to the first quadrant, the bits 00 are allocated to the second quadrant, the bits 01 are allocated to the third quadrant, and the bits 11 are allocated to the fourth quadrant in the complex plane. In this case, the hard decision unit 402 converts the modulation signal, which is the reception signal received from the clock recovery/equalizer 401, to digital bits. Due to this conversion, a hard decision output signal output by the hard decision unit 402 is one of the digital bits 00, 01, 10, and 11. Then, if the modulation signal that is the reception signal received from the clock recovery/equalizer 401 is in the first quadrant, the hard decision unit 402 decides on the bits 10. Additionally, if the modulation signal that is the reception signal received from the clock recovery/equalizer 401 is in the second quadrant, the hard decision unit 402 decides on the bits 00. Additionally, if the modulation signal that is the reception signal received from the clock recovery/equalizer 401 is in the third quadrant, the hard decision unit 402 decides on the bits 01. Additionally, if the modulation signal that is the reception signal received from the clock recovery/equalizer 401 is in the fourth quadrant, the hard decision unit 402 decides on the bits 11. The hard decision unit 402 outputs the decision results to the coefficient updating unit 50a.

The mapping unit 502 receives the decision results of the hard decision unit 402 from the reception demodulator 40a. The mapping unit 502 replaces the received decision results with signal points in accordance with a modulation scheme. That is, the mapping unit 502 converts the received reception signal to the ideal signal d (step S1). Then, the mapping unit 502 outputs the ideal signal d to the error calculation unit 501, the harmonic calculation unit 503, and the compensation coefficient updating unit 504.

The error calculation unit 501 receives the reception signal from the clock recovery/equalizer 401. Additionally, the error calculation unit 501 receives, from the mapping unit 502, the ideal signal d. Then, the error calculation unit 501 calculates the error signal e by subtracting the reception signal from the ideal signal d (step S2). The error calculation unit 501 outputs the error signal e, which is the subtraction result, to the compensation coefficient updating unit 504.

The harmonic calculation unit 503 receives the ideal signal d from the mapping unit 502. The harmonic calculation unit 503 calculates harmonics of the ideal signal d based on the received ideal signal d (step S3). For example, the first calculation unit 503a calculates the third harmonic of the ideal signal d by calculating the third power of the ideal signal d. Additionally, for example, the second calculation unit 503b calculates the fifth harmonic of the ideal signal d by calculating the fifth power of the ideal signal d. The first calculation unit 503a and the second calculation unit 503b respectively output the calculated harmonics of the ideal signal d to the compensation coefficient updating unit 504.

The compensation coefficient updating unit 504 receives the ideal signal d from the mapping unit 502. Additionally, the compensation coefficient updating unit 504 receives the harmonics of the ideal signal d from the harmonic calculation unit 503. Additionally, the compensation coefficient updating unit 504 receives the error signal e from the error calculation unit 501. The compensation coefficient updating unit 504 uses an adaptive algorithm, based on the received ideal signal d, the received harmonics of the ideal signal d, and the received error signal e, to generate compensation coefficients p to be used by the transmission modulator 10a when compensating for the non-linear distortion that mainly occurs due to the amplifier 203 in the local station apparatus 1a (step S4). Then, the compensation coefficient updating unit 504 outputs the generated coefficients p1, p3, and p5, as the compensation coefficients p, to the transmission modulator 10a.

The DPD compensation unit 101 compensates for non-linear distortion by using pre-distortion technology in which transmission signals are provided with inverse characteristics, which are characteristics that cancel out non-linear distortion. For example, the DPD compensation unit 101 receives a modulation signal that is a digital signal generated in the transmission modulator 10a. The DPD compensation unit 101 provides the modulation signal with the inverse characteristics for cancelling out non-linear distortion occurring in the local station apparatus 1a based on the compensation coefficients p received from the coefficient updating unit 50a (step S5).

### (Advantages)

The communication system 1 according to the first embodiment of the present disclosure has been explained above. In the communication system 1, the error calculation unit 501 (an example of a first generating means) generates the error signal e based on the ideal signal d, which is generated based on the output signal from the hard decision unit 402 (an example of the deciding means) that performs a hard decision, and on the input signal to the hard decision unit 402. The compensation coefficient updating unit 504 (an example of a second generating means) generates the compensation coefficients p for compensating for non-linear distortion included in the modulation signal, which is the transmission signal, based on the error signal e. The DPD compensation unit 101 (an example of a compensating means) compensates for the non-linear distortion based on the compensation coefficients p.

Due to this communication system 1, non-linear distortion included in the modulation signal, which is the transmission signal, can be compensated without directly using the input modulation signal to generate coefficients for compensating for the non-linear distortion.

### Second Embodiment

### (Configuration of Communication System)

Next, a communication system 1 according to a second embodiment of the present disclosure will be explained. FIG. 6 is a diagram illustrating an example of the configuration of the communication system 1 according to the second embodiment of the present disclosure. The communication system 1, as illustrated in FIG. 6, is provided with a local station apparatus 1a and a counterpart station apparatus 1b. The local station apparatus 1a, as illustrated in FIG. 6, is provided with a transmission modulator 10a, an analog transmission unit 20a, and a receiver 60a.

The transmission modulator 10a has a configuration similar to that of the transmission modulator 10a according to the first embodiment of the present disclosure. The analog transmission unit 20a has a configuration similar to that of the analog transmission unit 20a according to the first embodiment of the present disclosure. However, the transmission modulator 10a receives the compensation coefficients p from the receiver 60a. Additionally, the amplifier 203 in the analog transmission unit 20a transmits a transmission signal, which includes the amplified modulation signal and non-linear components thereof, to the counterpart station apparatus 1b.

The receiver 60a receives, from the counterpart station apparatus 1b, one frame of data including the compensation coefficients p. The receiver 60a identifies the compensation coefficients p in the one frame of data that has been received. The receiver 60a outputs the identified compensation coefficients p to the transmission modulator 10a.

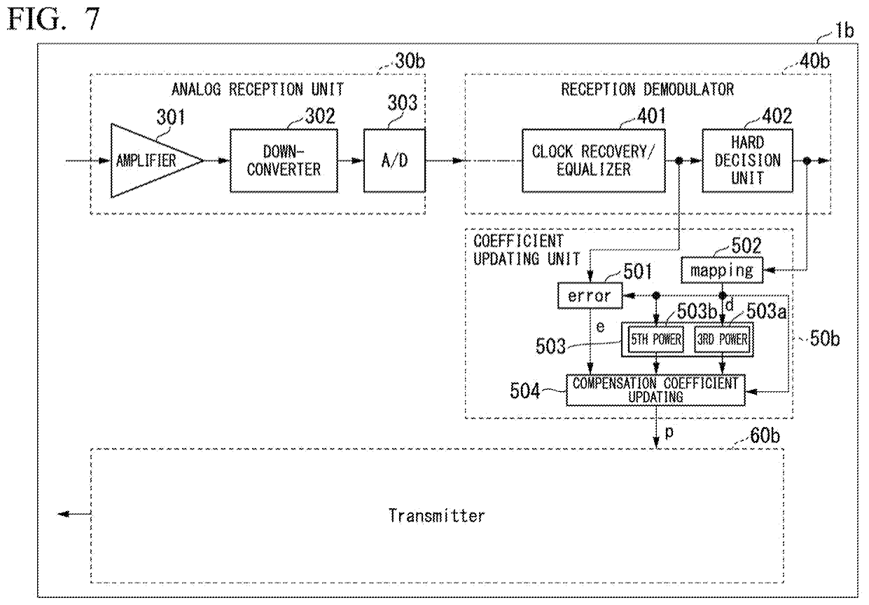

FIG. 7 is a diagram illustrating an example of the configuration of the counterpart station apparatus 1b according to the second embodiment of the present disclosure. The counterpart station apparatus 1b, as illustrated in FIG. 7, is provided with an analog reception unit 30b, a reception demodulator 40b, a coefficient updating unit 50b, and a transmitter 60b.

The analog reception unit 30b, as illustrated in FIG. 7, is provided with an amplifier 301, a down-converter 302, and an A/D converter 303, like the analog feedback reception unit 30a according to the first embodiment of the present disclosure.

The amplifier 301 receives, as a reception signal, the transmission signal (i.e., the signal including the modulation signal and the non-linear distortion components of that modulation signal) transmitted by the local station apparatus 1a. The amplifier 301 amplifies the reception signal. The amplifier 301 outputs the amplified reception signal to the down-converter 302.

The down-converter 302 receives the reception signal from the amplifier 301. The reception signal received by the down-converter 302 is a signal in the RF frequency band. The down-converter 302 converts the frequency band of the reception signal from RF to BB. The down-converter 302 outputs the converted reception signal to the A/D converter 303.

The A/D converter 303 receives the reception signal from the down-converter 302. The reception signal received by the A/D converter 303 is an analog signal. The A/D converter 303 converts the received reception signal from an analog signal to a digital signal. The sampling frequency when the A/D converter 303 converts the reception signal from an analog signal to a digital signal is a frequency that is m times the symbol rate, where m is a value equal to or greater than 2. The A/D converter 303 outputs the converted reception signal to the reception demodulator 40b.

The reception demodulator 40b, as illustrated in FIG. 7, is provided with a clock recovery/equalizer 401 and a hard decision unit 402, like the reception demodulator 40a according to the first embodiment of the present disclosure.

The clock recovery/equalizer 401 receives the reception signal from the analog reception unit 30b. The clock recovery/equalizer 401 corrects the frequency characteristics of the received reception signal and synchronizes the modulation signal, which is the reception signal, with a clock signal. Due to the clock recovery/equalizer 401 performing the process of correcting the frequency characteristics of the reception signal and synchronizing the reception signal with a symbol clock, a reception signal that has been oversampled by the A/D converter 303 is converted to a reception signal at the symbol rate. The clock recovery/equalizer 401 corrects the frequency characteristics of the reception signal and outputs the reception signal resulting after having performed a process for synchronizing the modulation signal, which is the reception signal, with the clock signal, to the hard decision unit 402 and the coefficient updating unit 50b.

The hard decision unit 402 receives the reception signal from the clock recovery/equalizer 401. The hard decision unit 402 determines what kind of signal the received reception signal is. For example, suppose that a QPSK modulation scheme is used, and as indicated in FIG. 3, the bits 10 are allocated to the first quadrant, the bits 00 are allocated to the second quadrant, the bits 01 are allocated to the third quadrant, and the bits 11 are allocated to the fourth quadrant in the complex plane. In this case, the hard decision unit 402 converts the modulation signal, which is the reception signal received from the clock recovery/equalizer 401, to digital bits. Due to this conversion, a hard decision output signal output by the hard decision unit 402 is one of the digital bits 00, 01, 10, and 11. Then, if the modulation signal that is the reception signal received from the clock recovery/equalizer 401 is in the first quadrant, the hard decision unit 402 decides on the bits 10. Additionally, if the modulation signal that is the reception signal received from the clock recovery/equalizer 401 is in the second quadrant, the hard decision unit 402 decides on the bits 00. Additionally, if the modulation signal that is the reception signal received from the clock recovery/equalizer 401 is in the third quadrant, the hard decision unit 402 decides on the bits 01. Additionally, if the modulation signal that is the reception signal received from the clock recovery/equalizer 401 is in the fourth quadrant, the hard decision unit 402 decides on the bits 11. The hard decision unit 402 outputs the decision results to the coefficient updating unit 50b.

The coefficient updating unit 50b generates compensation coefficients p to be used by the transmission modulator 10a when compensating for non-linear distortion that mainly occurs due to the amplifier 203 in the local station apparatus 1a. The coefficient updating unit 50b, as illustrated in FIG. 7, is provided with an error calculation unit 501, a mapping unit 502, a harmonic calculation unit 503, and a compensation coefficient updating unit 504, like the coefficient updating unit 50a according to the first embodiment of the present disclosure. The coefficient updating unit 50b operates at the symbol rate.

The error calculation unit 501 receives the reception signal from the clock recovery/equalizer 401. Additionally, the error calculation unit 501 receives, from the mapping unit 502, the ideal signal d. Then, the error calculation unit 501 subtracts the reception signal from the ideal signal d. The error calculation unit 501 outputs the subtraction result, as an error signal e, to the compensation coefficient updating unit 504. The error signal e is complex.

The mapping unit 502 receives the decision result of the hard decision unit 402 from the reception demodulator 40b. The mapping unit 502 replaces the received decision results with signal points in accordance with a modulation scheme. For example, in the case in which a QPSK modulation scheme is used as the modulation scheme, when a decision result indicating the bits 10 indicating the first quadrant is received, the mapping unit 502 replaces that decision result with a signal point corresponding to the first quadrant (for example, signal point Pt1 indicated in FIG. 3). Additionally, when a decision result indicating the bits 00 indicating the second quadrant is received, the mapping unit 502 replaces that decision result with a signal point corresponding to the second quadrant (for example, signal point Pt2 indicated in FIG. 3). Additionally, when a decision result indicating the bits 01 indicating the third quadrant is received, the mapping unit 502 replaces that decision result with a signal point corresponding to the third quadrant (for example, signal point Pt3 indicated in FIG. 3). Additionally, when a decision result indicating the bits 11 indicating the fourth quadrant is received, the mapping unit 502 replaces that decision result with a signal point corresponding to the fourth quadrant (for example, signal point Pt4 indicated in FIG. 3). The signal points corresponding respectively to the first quadrant to the fourth quadrant correspond to an ideal modulation signal (i.e., an ideal signal d which is a modulation signal including an amplitude and a phase that was actually supposed to be transmitted). For this reason, the mapping unit 502 converts the received reception signal to the ideal signal d by performing the replacement process on signal points corresponding to one of the first quadrant to the fourth quadrant on the complex plane. This ideal signal d is complex. Then, the mapping unit 502 outputs the ideal signal d to the error calculation unit 501, the harmonic calculation unit 503, and the compensation coefficient updating unit 504.

The harmonic calculation unit 503 is provided with a first calculation unit 503a and a second calculation unit 503b. The harmonic calculation unit 503 receives the ideal signal d from the mapping unit 502. The harmonic calculation unit 503 calculates harmonics of the ideal signal d based on the received ideal signal d. For example, the first calculation unit 503a calculates the third harmonic of the ideal signal d by calculating the third power of the ideal signal d. Additionally, for example, the second calculation unit 503b calculates the fifth harmonic of the ideal signal d by calculating the fifth power of the ideal signal d. The first calculation unit 503a and the second calculation unit 503b respectively output the calculated harmonics of the ideal signal d to the compensation coefficient updating unit 504.

The compensation coefficient updating unit 504 receives the ideal signal d from the mapping unit 502. Additionally, the compensation coefficient updating unit 504 receives the harmonics of the ideal signal d from the harmonic calculation unit 503. Additionally, the compensation coefficient updating unit 504 receives the error signal e from the error calculation unit 501. The compensation coefficient updating unit 504 uses an adaptive algorithm, based on the received ideal signal d, the received harmonics of the ideal signal d, and the received error signal e, to generate compensation coefficients p to be used by the transmission modulator 10a when compensating for the non-linear distortion that mainly occurs due to the amplifier 203 in the local station apparatus 1a.

For example, when LMS is used as the adaptive algorithm and the compensation coefficients p are updated for each symbol, the compensation coefficient updating unit 504 generates the coefficient p1 by performing the calculation in Expression (1). Additionally, the compensation coefficient updating unit 504 generates the coefficient p3 by performing the calculation in Expression (2). Additionally, the compensation coefficient updating unit 504 generates the coefficient p5 by performing the calculation in Expression (3).

Additionally, for example, when block LMS is used as the adaptive algorithm and the compensation coefficients p are updated for every L symbols, the compensation coefficient updating unit 504 generates the coefficient p1 by performing the calculation in Expression (4). Additionally, the compensation coefficient updating unit 504 generates the coefficient p3 by performing the calculation in Expression (5). Additionally, the compensation coefficient updating unit 504 generates the coefficient p5 by performing the calculation in Expression (6).

Then, the compensation coefficient updating unit 504 outputs the generated coefficients p1, p3, and p5, as the compensation coefficients p, to the transmitter 60b. For example, the compensation coefficient updating unit 504 performs processes using digital pre-distortion technology.

The transmitter 60b receives the compensation coefficients p from the coefficient updating unit 50b. The transmitter 60b generates one frame of data including the received compensation coefficients p. The transmitter 60b transmits the generated one frame of data to the local station apparatus 1a.

Next, the processes performed by the communication system 1 according to the second embodiment of the present disclosure will be explained. In this case, the process performed by the communication system 1 to compensate for the non-linear distortion components included in the transmission signal from the analog transmission unit 20a by using the compensation coefficients p will be explained.

The amplifier 203 in the analog transmission unit 20a transmits a transmission signal including an amplified modulation signal and non-linear distortion components thereof to the counterpart station apparatus 1b. The amplifier 301 in the analog reception unit 30b receives, as a reception signal, the transmission signal transmitted by the local station apparatus 1a. The amplifier 301 in the analog reception unit 30b amplifies the reception signal. The amplifier 301 in the analog reception unit 30b outputs the amplified reception signal to the down-converter 302 in the analog reception unit 30b.

The down-converter 302 in the analog reception unit 30b receives the reception signal from the amplifier 301 in the analog reception unit 30b. The down-converter 302 in the analog reception unit 30b converts the frequency band of the reception signal from RF to BB. The down-converter 302 in the analog reception unit 30b outputs the converted reception signal to the A/D converter 303 in the analog reception unit 30b.

The A/D converter 303 in the analog reception unit 30b receives the reception signal from the down-converter 302 in the analog reception unit 30b. The A/D converter 303 in the analog reception unit 30b converts the received reception signal from an analog signal to a digital signal. The A/D converter 303 in the analog reception unit 30b outputs the converted reception signal to the reception demodulator 40b.

The clock recovery/equalizer 401 in the reception demodulator 40b receives the reception signal from the analog reception unit 30b. The clock recovery/equalizer 401 in the reception demodulator 40b corrects the frequency characteristics of the received reception signal and synchronizes the modulation signal, which is the reception signal, with a clock signal. The clock recovery/equalizer 401 in the reception demodulator 40b corrects the frequency characteristics of the reception signal and outputs the reception signal resulting after having performed a process for synchronizing the modulation signal, which is the reception signal, with the clock signal, to the hard decision unit 402 in the reception demodulator 40b and the coefficient updating unit 50b.

The hard decision unit 402 in the reception demodulator 40b receives the reception signal from the clock recovery/equalizer 401 in the reception demodulator 40b. The hard decision unit 402 in the reception demodulator 40b determines what kind of signal the received reception signal is. For example, suppose that a QPSK modulation scheme is used, and as indicated in FIG. 3, the bits 10 are allocated to the first quadrant, the bits 00 are allocated to the second quadrant, the bits 01 are allocated to the third quadrant, and the bits 11 are allocated to the fourth quadrant in the complex plane. In this case, the hard decision unit 402 in the reception demodulator 40b converts the modulation signal, which is the reception signal received from the clock recovery/equalizer 401 in the reception demodulator 40b, to digital bits. Due to this conversion, a hard decision output signal output by the hard decision unit 402 in the reception demodulator 40b is one of the digital bits 00, 01, 10, and 11. Then, if the modulation signal that is the reception signal received from the clock recovery/equalizer 401 in the reception demodulator 40b is in the first quadrant, the hard decision unit 402 in the reception demodulator 40b decides on the bits 10. Additionally, if the modulation signal that is the reception signal received from the clock recovery/equalizer 401 in the reception demodulator 40b is in the second quadrant, the hard decision unit 402 in the reception demodulator 40b decides on the bits 00. Additionally, if the modulation signal that is the reception signal received from the clock recovery/equalizer 401 in the reception demodulator 40b is in the third quadrant, the hard decision unit 402 in the reception demodulator 40b decides on the bits 01. Additionally, if the modulation signal that is the reception signal received from the clock recovery/equalizer 401 in the reception demodulator 40b is in the fourth quadrant, the hard decision unit 402 in the reception demodulator 40b decides on the bits 11. The hard decision unit 402 in the reception demodulator 40b outputs the decision results to the coefficient updating unit 50b.

Then, in the coefficient updating unit 50b, the error calculation unit 501, the mapping unit 502, the harmonic calculation unit 503, and the compensation coefficient updating unit 504 perform the process in step S1 to step S4, like the error calculation unit 501, the mapping unit 502, the harmonic calculation unit 503, and the compensation coefficient updating unit 504 according to the first embodiment of the present disclosure. Furthermore, the compensation coefficient updating unit 504 in the coefficient updating unit 50b outputs the generated coefficients p1, p3, and p5, as the compensation coefficients p, to the transmitter 60b.

The transmitter 60b receives the compensation coefficients p from the coefficient updating unit 50b. The transmitter 60b generates one frame of data including the received compensation coefficients p. The transmitter 60b transmits the generated one frame of data to the local station apparatus 1a.

The receiver 60a receives, from the counterpart station apparatus 1b, one frame of data including the compensation coefficients p. The receiver 60a identifies the compensation coefficients p in the one frame of data that has been received. The receiver 60a outputs the identified compensation coefficients p to the local station apparatus 1a.

The DPD compensation unit 101 in the transmission modulator 10a compensates for non-linear distortion by using pre-distortion technology in which transmission signals are provided with inverse characteristics, which are characteristics that cancel out non-linear distortion. For example, the DPD compensation unit 101 in the transmission modulator 10a receives a modulation signal that is a digital signal generated in the transmission modulator 10a. The DPD compensation unit 101 in the transmission modulator 10a provides the modulation signal with the inverse characteristics for cancelling out non-linear distortion occurring in the local station apparatus 1a based on the compensation coefficients p received from the counterpart station apparatus 1b.

### (Advantages)

The communication system 1 according to the second embodiment of the present disclosure has been explained above. In the counterpart station apparatus 1b in the communication system 1, the error calculation unit 501 (an example of a first generating means) generates the error signal e based on the ideal signal d, which is generated based on the output signal from the hard decision unit 402 (an example of the deciding means) that performs a hard decision, and on the input signal to the hard decision unit 402. The compensation coefficient updating unit 504 (an example of a second generating means) generates the compensation coefficients p for compensating for non-linear distortion included in the modulation signal, which is the transmission signal, based on the error signal e. The DPD compensation unit 101 (an example of a compensating means) in the local station apparatus 1 compensates for the non-linear distortion based on the compensation coefficients p.

Due to this communication system 1, non-linear distortion included in the modulation signal, which is the transmission signal, can be compensated without directly using the input modulation signal to generate coefficients for compensating for the non-linear distortion, by using the compensation coefficients p, which are generated in the counterpart station apparatus 1b, in the local station apparatus 1a.

### <Modified Example of Second Embodiment>

### (Configuration of Communication System)

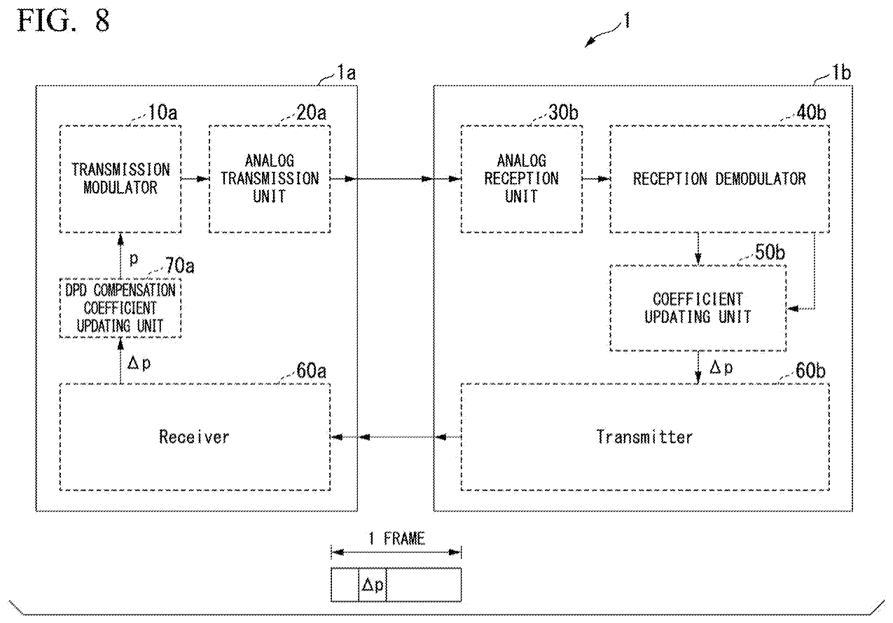

Next, a communication system 1 according to a modified example of the second embodiment of the present disclosure will be explained. FIG. 8 is a diagram illustrating an example of the configuration of the communication system 1 according to the modified example of the second embodiment of the present disclosure. The communication system 1, as illustrated in FIG. 8, is provided with a local station apparatus 1a and a counterpart station apparatus 1b. The local station apparatus 1a, as illustrated in FIG. 8, is provided with a transmission modulator 10a, an analog transmission unit 20a, a receiver 60a, and a DPD compensation coefficient updating unit 70a.

The transmission modulator 10a has a configuration similar to that of the transmission modulator 10a according to the second embodiment of the present disclosure. The analog transmission unit 20a has a configuration similar to that of the analog transmission unit 20a according to the second embodiment of the present disclosure. The receiver 60a has a configuration similar to that of the receiver 60a according to the second embodiment of the present disclosure. However, the transmission modulator 10a receives the compensation coefficients p from the DPD compensation coefficient updating unit 70a. Additionally, the receiver 60a receives one frame of data including compensation coefficient update amounts Δp from the counterpart station apparatus 1b. Additionally, the receiver 60a identifies the compensation coefficient update amounts Δp in the one frame of data that has been received. Additionally, the receiver 60a outputs the identified compensation coefficient update amounts Δp to the DPD compensation coefficient updating unit 70a.

The DPD compensation coefficient updating unit 70a receives one frame of data including the compensation coefficient update amounts Δp from the receiver 60a. The DPD compensation coefficient updating unit 70a identifies the compensation coefficient update amounts Δp in the one frame of data that has been received. The DPD compensation coefficient updating unit 70a generates compensation coefficients p based on the identified compensation coefficient update amounts Δp.

For example, when block LMS is used as the adaptive algorithm and the compensation coefficient update amounts Δp are updated for every L symbols, the DPD compensation coefficient updating unit 70a generates the coefficient p1 by performing the computation indicated by Expression (7), using Δp1 among the identified compensation coefficient update amounts Δp. Additionally, the DPD compensation coefficient updating unit 70a generates the coefficient p3 by performing the computation indicated by Expression (8), using Δp3 among the identified compensation coefficient update amounts Δp. Additionally, the DPD compensation coefficient updating unit 70a generates the coefficient p5 by performing the computation indicated by Expression (9), using Δp5 among the identified compensation coefficient update amounts Δp.

$$\\ \begin{matrix}[ Mathematical Expression 7 ] & \\ {p}_{1} ( k + L ) = {p}_{1} ( k ) + Δ {p}_{1} ( k + L ) & ( 7 )\end{matrix}$$

$$\\ \begin{matrix}[ Mathematical Expression 8 ] & \\ {p}_{3} ( k + L ) = {p}_{3} ( k ) + Δ {p}_{3} ( k + L ) & ( 8 )\end{matrix}$$

$$\\ \begin{matrix}[ Mathematical Expression 9 ] & \\ {p}_{5} ( k + L ) = {p}_{5} ( k ) + Δ {p}_{5} ( k + L ) & ( 9 )\end{matrix}$$

Then, the DPD compensation coefficient updating unit 70a outputs the generated coefficients p1, p3, and p5, as the compensation coefficients p, to the transmission modulator 10a.

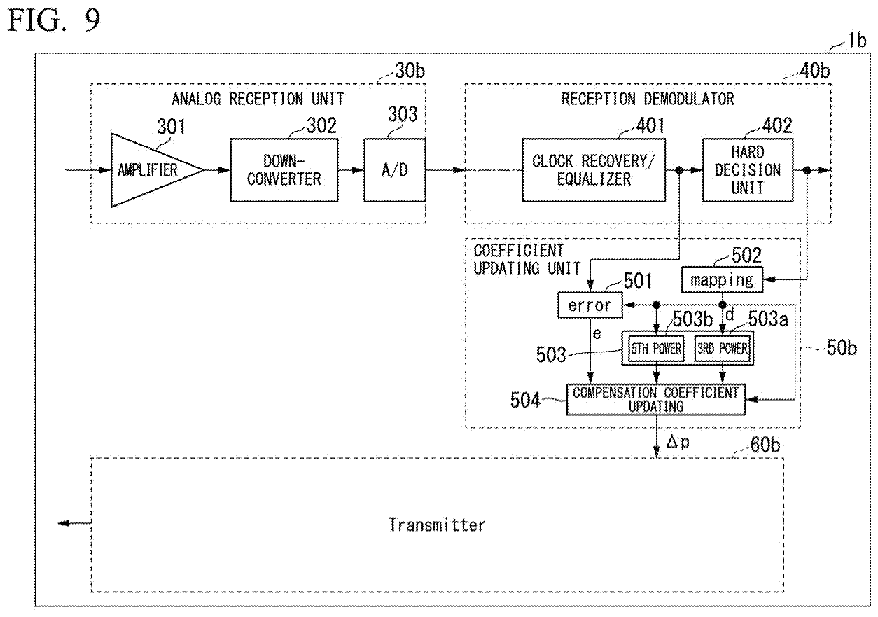

FIG. 9 is a diagram illustrating an example of the configuration of a counterpart station apparatus 1b according to a modified example of the second embodiment of the present disclosure. The counterpart station apparatus 1b, as illustrated in FIG. 9, is provided with an analog reception unit 30b, a reception demodulator 40b, a coefficient updating unit 50b, and a receiver 60b. The counterpart station apparatus 1b has a different coefficient updating unit 50b and transmitter 60b from those in the counterpart station apparatus 1b according to the second embodiment of the present disclosure.

The coefficient updating unit 50b generates compensation coefficient update amounts Δp to be used by the transmission modulator 10a when compensating for non-linear distortion that mainly occurs due to the amplifier 203 in the local station apparatus 1a. The coefficient updating unit 50b, as illustrated in FIG. 9, is provided with an error calculation unit 501, a mapping unit 502, a harmonic calculation unit 503, and a compensation coefficient updating unit 504, like the coefficient updating unit 50b according to the second embodiment of the present disclosure. The coefficient updating unit 50b operates at the symbol rate.

The error calculation unit 501, the mapping unit 502, and the harmonic calculation unit 503 respectively perform processes similar to those in the error calculation unit 501, the mapping unit 502, and the harmonic calculation unit 503 according to the second embodiment of the present disclosure.

The compensation coefficient updating unit 504 receives the harmonics of the ideal signal d from the harmonic calculation unit 503. Additionally, the compensation coefficient updating unit 504 receives the error signal e from the error calculation unit 501. The compensation coefficient updating unit 504 uses an adaptive algorithm, based on the received harmonics of the ideal signal d and the received error signal e, to generate compensation coefficient update amounts Δp to be used by the transmission modulator 10a when compensating for the non-linear distortion that mainly occurs due to the amplifier 203 in the local station apparatus 1a.

For example, when block LMS is used as the adaptive algorithm and the compensation coefficient update amounts Δp are updated for every L symbols, the compensation coefficient updating unit 504 generates the coefficient Δp1 by performing the computation indicated by Expression (10). Additionally, the compensation coefficient updating unit 504 generates the coefficient Δp3 by performing the computation indicated by Expression (11). Additionally, the compensation coefficient updating unit 504 generates the coefficient Δp5 by performing the computation indicated by Expression (12). Then, the compensation coefficient updating unit 504 outputs the generated coefficients Δp1, Δp3, and Δp5, as the compensation coefficient update amounts Δp, to the transmitter 60b. For example, the compensation coefficient updating unit 504 performs processes using digital pre-distortion technology.

$$\\ \begin{matrix}[ Mathematical Expression 10 ] & \\ Δ {p}_{1} ( k + L ) = {μ}_{p 1} {\sum }_{l = k}^{k + L - 1} d ( l ) {e}^{{}_{} *} ( l ) & ( 10 )\end{matrix}$$

$$\\ \begin{matrix}[ Mathematical Expression 11 ] & \\ Δ {p}_{3} ( k + L ) = {μ}_{p 3} {\sum }_{l = k}^{k + L - 1} {\vert d ( l ) \vert}^{2} d ( l ) {e}^{{}_{} *} ( l ) & ( 11 )\end{matrix}$$

$$\\ \begin{matrix}[ Mathematical Expression 12 ] & \\ Δ {p}_{5} ( k + L ) = {μ}_{p 5} {\sum }_{l = k}^{k + L - 1} {\vert d ( k ) \vert}^{4} d ( k ) {e}^{{}_{} *} ( k ) & ( 12 )\end{matrix}$$

The transmitter 60b receives the compensation coefficient update amounts Δp from the coefficient updating unit 50b. The transmitter 60b generates one frame of data including the received compensation coefficient update amounts Δp. The transmitter 60b transmits the generated one frame of data to the local station apparatus 1a.

Next, the processes performed by the communication system 1 according to the modified example of the second embodiment of the present disclosure will be explained. In this case, the process performed by the communication system 1 to compensate for the non-linear distortion components included in the transmission signal from the analog transmission unit 20a by using the compensation coefficient update amounts Δp will be explained.

The amplifier 203 in the analog transmission unit 20a transmits a transmission signal including an amplified modulation signal and non-linear distortion components thereof to the counterpart station apparatus 1b. The amplifier 301 in the analog reception unit 30b receives, as a reception signal, the transmission signal transmitted by the local station apparatus 1a. The amplifier 301 in the analog reception unit 30b amplifies the reception signal. The amplifier 301 in the analog reception unit 30b outputs the amplified reception signal to the down-converter 302 in the analog reception unit 30b.

The down-converter 302 in the analog reception unit 30b receives the reception signal from the amplifier 301 in the analog reception unit 30b. The down-converter 302 in the analog reception unit 30b converts the frequency band of the reception signal from RF to BB. The down-converter 302 in the analog reception unit 30b outputs the converted reception signal to the A/D converter 303 in the analog reception unit 30b.

The A/D converter 303 in the analog reception unit 30b receives the reception signal from the down-converter 302 in the analog reception unit 30b. The A/D converter 303 in the analog reception unit 30b converts the received reception signal from an analog signal to a digital signal. The A/D converter 303 in the analog reception unit 30b outputs the converted reception signal to the reception demodulator 40b.

The clock recovery/equalizer 401 in the reception demodulator 40b receives the reception signal from the analog reception unit 30b. The clock recovery/equalizer 401 in the reception demodulator 40b corrects the frequency characteristics of the received reception signal and synchronizes the modulation signal, which is the reception signal, with a clock signal. The clock recovery/equalizer 401 in the reception demodulator 40b corrects the frequency characteristics of the reception signal and outputs the reception signal resulting after having performed a process for synchronizing the modulation signal, which is the reception signal, with the clock signal, to the hard decision unit 402 in the reception demodulator 40b and the coefficient updating unit 50b.

The hard decision unit 402 in the reception demodulator 40b receives the reception signal from the clock recovery/equalizer 401 in the reception demodulator 40b. The hard decision unit 402 in the reception demodulator 40b determines what kind of signal the received reception signal is. For example, suppose that a QPSK modulation scheme is used, and as indicated in FIG. 3, the bits 10 are allocated to the first quadrant, the bits 00 are allocated to the second quadrant, the bits 01 are allocated to the third quadrant, and the bits 11 are allocated to the fourth quadrant in the complex plane. In this case, the hard decision unit 402 in the reception demodulator 40b converts the modulation signal, which is the reception signal received from the clock recovery/equalizer 401 in the reception demodulator 40b, to digital bits. Due to this conversion, a hard decision output signal output by the hard decision unit 402 in the reception demodulator 40b is one of the digital bits 00, 01, 10, and 11. Then, if the modulation signal that is the reception signal received from the clock recovery/equalizer 401 in the reception demodulator 40b is in the first quadrant, the hard decision unit 402 in the reception demodulator 40b decides on the bits 10. Additionally, if the modulation signal that is the reception signal received from the clock recovery/equalizer 401 in the reception demodulator 40b is in the second quadrant, the hard decision unit 402 in the reception demodulator 40b decides on the bits 00. Additionally, if the modulation signal that is the reception signal received from the clock recovery/equalizer 401 in the reception demodulator 40b is in the third quadrant, the hard decision unit 402 in the reception demodulator 40b decides on the bits 01. Additionally, if the modulation signal that is the reception signal received from the clock recovery/equalizer 401 in the reception demodulator 40b is in the fourth quadrant, the hard decision unit 402 in the reception demodulator 40b decides on the bits 11. The hard decision unit 402 in the reception demodulator 40b outputs the decision results to the coefficient updating unit 50b.

Then, in the coefficient updating unit 50b, the error calculation unit 501, the mapping unit 502, the harmonic calculation unit 503, and the compensation coefficient updating unit 504 perform the process in step S1 to step S3, like the error calculation unit 501, the mapping unit 502, the harmonic calculation unit 503, and the compensation coefficient updating unit 504 according to the first embodiment of the present disclosure.

The compensation coefficient updating unit 504 receives the harmonics of the ideal signal d from the harmonic calculation unit 503. Additionally, the compensation coefficient updating unit 504 receives the error signal e from the error calculation unit 501. The compensation coefficient updating unit 504 uses an adaptive algorithm, based on the received harmonics of the ideal signal d and the received error signal e, to generate compensation coefficient update amounts Δp to be used by the transmission modulator 10a when compensating for the non-linear distortion that mainly occurs due to the amplifier 203 in the local station apparatus 1a.

For example, when block LMS is used as the adaptive algorithm and the compensation coefficient update amounts Δp are updated for every L symbols, the compensation coefficient updating unit 504 generates the coefficient Δp1 by performing the computation indicated by Expression (10). Additionally, the compensation coefficient updating unit 504 generates the coefficient Δp3 by performing the computation indicated by Expression (11). Additionally, the compensation coefficient updating unit 504 generates the coefficient Δp5 by performing the computation indicated by Expression (12). Then, the compensation coefficient updating unit 504 outputs the generated coefficients Δp1, Δp3, and Δp5, as the compensation coefficient update amounts Δp, to the transmitter 60b.

The transmitter 60b receives the compensation coefficient update amounts Δp from the coefficient updating unit 50b. The transmitter 60b generates one frame of data including the received compensation coefficient update amounts Δp. The transmitter 60b transmits the generated one frame of data to the local station apparatus 1a.

The receiver 60a receives, from the counterpart station apparatus 1b, one frame of data including the compensation coefficient update amounts Δp. Additionally, the receiver 60a identifies the compensation coefficient update amounts Δp in the one frame of data that has been received. Additionally, the receiver 60a outputs the identified compensation coefficient update amounts Δp to the DPD compensation coefficient updating unit 70a.

The DPD compensation coefficient updating unit 70a receives one frame of data including the compensation coefficient update amounts Δp from the receiver 60a. The DPD compensation coefficient updating unit 70a identifies the compensation coefficient update amounts Δp in the one frame of data that has been received. The DPD compensation coefficient updating unit 70a generates compensation coefficients p based on the identified compensation coefficient update amounts Δp.

For example, when block LMS is used as the adaptive algorithm and the compensation coefficient update amounts Δp are updated for every L symbols, the DPD compensation coefficient updating unit 70a generates the coefficient p1 by performing the computation indicated by Expression (7), using Δp1 among the identified compensation coefficient update amounts Δp. Additionally, the DPD compensation coefficient updating unit 70a generates the coefficient p3 by performing the computation indicated by Expression (8), using Δp3 among the identified compensation coefficient update amounts Δp. Additionally, the DPD compensation coefficient updating unit 70a generates the coefficient p5 by performing the computation indicated by Expression (9), using Δp5 among the identified compensation coefficient update amounts Δp.

Then, the DPD compensation coefficient updating unit 70a outputs the generated coefficients p1, p3, and p5, as the compensation coefficients p, to the transmission modulator 10a.

The DPD compensation unit 101 compensates for non-linear distortion by using pre-distortion technology in which transmission signals are provided with inverse characteristics, which are characteristics that cancel out non-linear distortion. For example, the DPD compensation unit 101 receives a modulation signal that is a digital signal generated in the transmission modulator 10a. The DPD compensation unit 101 provides the modulation signal with the inverse characteristics for cancelling out non-linear distortion occurring in the local station apparatus 1a based on the compensation coefficients p received from the DPD compensation coefficient updating unit 70a.

### (Advantages)

The communication system 1 according to the modified example of the second embodiment of the present disclosure has been explained above. In the counterpart station apparatus 1b in the communication system 1, the error calculation unit 501 (an example of a first generating means) generates the error signal e based on the ideal signal d, which is generated based on the output signal from the hard decision unit 402 (an example of the deciding means) that performs a hard decision, and on the input signal to the hard decision unit 402. The compensation coefficient updating unit 504 (an example of a second generating means) generates the compensation coefficient update amounts Δp for compensating for non-linear distortion included in the modulation signal, which is the transmission signal, based on the error signal e. The DPD compensation coefficient updating unit 70a (an example of a third generating means) in the local station apparatus 1a generates the compensation coefficients p based on the compensation coefficient update amounts Δp. The DPD compensation unit 101 (an example of a compensating means) compensates for the non-linear distortion based on the compensation coefficients p.

In the communication system 1 according to the second embodiment of the present disclosure, when communication between the local station apparatus 1a and the counterpart station apparatus 1b is interrupted, the compensation coefficients p themselves cease to exist. Therefore, the change in the compensation coefficients p is large. In comparison therewith, in this communication system 1, the previous compensation coefficients p remain existing, and only the change in Δp remains being not reflected. For this reason, due to this communication system 1, sudden changes in the compensation coefficients p can be suppressed in comparison with the communication system 1 in the second embodiment of the present disclosure.

### Third Embodiment

### (Configuration of Communication System)

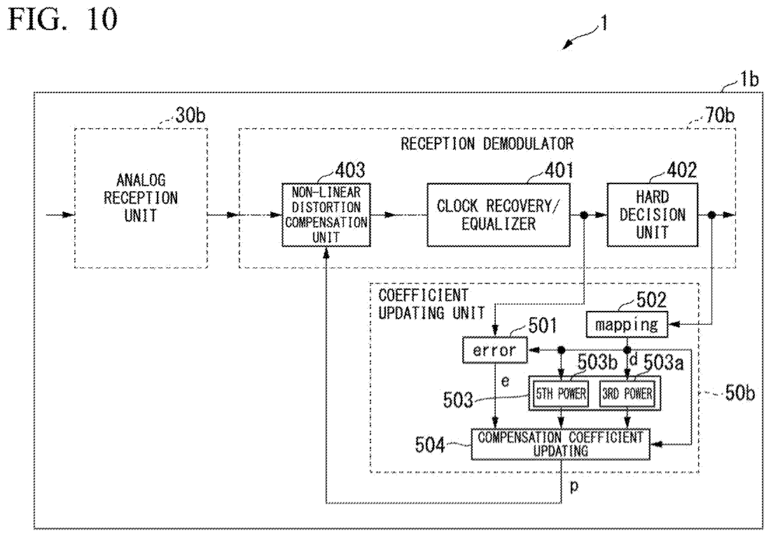

Next, a communication system 1 according to a third embodiment of the present disclosure will be explained. FIG. 10 is a diagram illustrating an example of the configuration of the communication system 1 according to the third embodiment of the present disclosure. The communication system 1, as illustrated in FIG. 10, is provided with a counterpart station apparatus 1b. The counterpart station apparatus 1b, as illustrated in FIG. 10, is provided with an analog reception unit 30b, a coefficient updating unit 50b, and a reception demodulator 70b.

The analog reception unit 30b has a configuration similar to that of the analog reception unit 30b according to the second embodiment of the present disclosure. The coefficient updating unit 50b has a configuration similar to that of the coefficient updating unit 50b according to the second embodiment of the present disclosure.

However, the A/D converter 303 in the analog reception unit 30b outputs the converted reception signal to the reception demodulator 70b. Additionally, the error calculation unit 501 in the coefficient updating unit 50b receives the reception signal from the clock recovery/equalizer 401 in the reception demodulator 70b. Additionally, the mapping unit 502 in the coefficient updating unit 50b receives the decision result of the hard decision unit 402 from the reception demodulator 70b. Additionally, the compensation coefficient updating unit 504 in the coefficient updating unit 50b outputs the generated coefficients p1, p3, and p5, as the compensation coefficients p, to the reception demodulator 70b. The compensation coefficient updating unit 504, unlike the compensation coefficient updating unit 504 in the first embodiment and the second embodiment (including the modified example), performs a process using post-distortion technology to compensate for non-linear distortion in a stage later than the amplifier, which is the main cause of the non-linear distortion.

The reception demodulator 70b, as illustrated in FIG. 10, is provided with a clock recovery/equalizer 401, a hard decision unit 402, and a non-linear distortion compensation unit 403.

The clock recovery/equalizer 401 receives the reception signal from the non-linear distortion compensation unit 403. The clock recovery/equalizer 401 corrects the frequency characteristics of the received reception signal and synchronizes the modulation signal, which is the reception signal, with a clock signal. Due to the clock recovery/equalizer 401 performing the process of correcting the frequency characteristics of the reception signal and synchronizing the reception signal with a symbol clock, a reception signal that has been oversampled by the A/D converter 303 is converted to a reception signal at the symbol rate. The clock recovery/equalizer 401 corrects the frequency characteristics of the reception signal and outputs the reception signal resulting after having performed a process for synchronizing the modulation signal, which is the reception signal, with the clock signal, to the hard decision unit 402 and the coefficient updating unit 50b. The hard decision unit 402 performs a process similar to that of the hard decision unit 402 according to the second embodiment of the present disclosure.

The non-linear distortion compensation unit 403 receives the compensation coefficients p from the coefficient updating unit 50b. The non-linear distortion compensation unit 403 compensates for the non-linear distortion in the reception signal based on the received compensation coefficients p. The non-linear distortion compensation unit 403 outputs the compensated reception signal to the clock recovery/equalizer 401.

Next, the processes performed by the communication system 1 according to the third embodiment of the present disclosure will be explained. In this case, the process performed by the communication system 1 to compensate for the non-linear distortion components included in the reception signal from the counterpart station apparatus 1b by using the compensation components p will be explained.

The amplifier 301 in the analog reception unit 30b receives a reception signal from an outside source. The amplifier 301 amplifies the reception signal. The amplifier 301 outputs the amplified reception signal to the down-converter 302 in the analog reception unit 30b.

The down-converter 302 receives the reception signal from the amplifier 301. The down-converter 302 converts the frequency band of the reception signal from RF to BB. The down-converter 302 outputs the converted reception signal to the A/D converter 303 in the analog reception unit 30b.

The A/D converter 303 receives the reception signal from the down-converter 302. The A/D converter 303 converts the received reception signal from an analog signal to a digital signal. The A/D converter 303 outputs the converted reception signal to the reception demodulator 40b.

The non-linear distortion compensation unit 403 in the reception demodulator 40b receives the reception signal from the analog reception unit 30b. Additionally, the non-linear distortion compensation unit 403 receives the compensation coefficients p from the coefficient updating unit 50b. The non-linear distortion compensation unit 403 compensates for the non-linear distortion in the reception signal based on the received compensation coefficients p. The non-linear distortion compensation unit 403 outputs the compensated reception signal to the clock recovery/equalizer 401.

The clock recovery/equalizer 401 in the reception demodulator 40b receives the reception signal from the non-linear distortion compensation unit 403. The clock recovery/equalizer 401 corrects the frequency characteristics of the received reception signal and synchronizes the modulation signal, which is the reception signal, with a clock signal. The clock recovery/equalizer 401 in the reception demodulator 40b corrects the frequency characteristics of the reception signal and outputs the reception signal resulting after having performed a process for synchronizing the modulation signal, which is the reception signal, with the clock signal, to the hard decision unit 402 in the reception demodulator 40b and the coefficient updating unit 50b.

The hard decision unit 402 in the reception demodulator 70b receives the reception signal from the clock recovery/equalizer 401 in the reception demodulator 70b. The hard decision unit 402 in the reception demodulator 70b determines what kind of signal the received reception signal is. For example, suppose that a QPSK modulation scheme is used, and as indicated in FIG. 3, the bits 10 are allocated to the first quadrant, the bits 00 are allocated to the second quadrant, the bits 01 are allocated to the third quadrant, and the bits 11 are allocated to the fourth quadrant in the complex plane. In this case, the hard decision unit 402 in the reception demodulator 70b converts the modulation signal, which is the reception signal received from the clock recovery/equalizer 401 in the reception demodulator 70b, to digital bits. Due to this conversion, a hard decision output signal output by the hard decision unit 402 in the reception demodulator 70b is one of the digital bits 00, 01, 10, and 11. Then, if the modulation signal that is the reception signal received from the clock recovery/equalizer 401 in the reception demodulator 70b is in the first quadrant, the hard decision unit 402 in the reception demodulator 70b decides on the bits 10. Additionally, if the modulation signal that is the reception signal received from the clock recovery/equalizer 401 in the reception demodulator 70b is in the second quadrant, the hard decision unit 402 in the reception demodulator 70b decides on the bits 00. Additionally, if the modulation signal that is the reception signal received from the clock recovery/equalizer 401 in the reception demodulator 70b is in the third quadrant, the hard decision unit 402 in the reception demodulator 70b decides on the bits 01. Additionally, if the modulation signal that is the reception signal received from the clock recovery/equalizer 401 in the reception demodulator 70b is in the fourth quadrant, the hard decision unit 402 in the reception demodulator 70b decides on the bits 11. The hard decision unit 402 in the reception demodulator 70b outputs the decision results to the coefficient updating unit 50b.

Then, in the coefficient updating unit 50b, the error calculation unit 501, the mapping unit 502, the harmonic calculation unit 503, and the compensation coefficient updating unit 504 perform the process in step S1 to step S4, like the error calculation unit 501, the mapping unit 502, the harmonic calculation unit 503, and the compensation coefficient updating unit 504 according to the first embodiment of the present disclosure. Furthermore, the compensation coefficient updating unit 504 in the coefficient updating unit 50b outputs the generated coefficients p1, p3, and p5, as the compensation coefficients p, to the non-linear distortion compensation unit 403.

### (Advantages)

The communication system 1 according to the third embodiment of the present disclosure has been explained above. In the communication system 1, the non-linear distortion compensation unit 403 compensates for the non-linear distortion in the reception signal based on the compensation coefficients p generated by the coefficient updating unit 50b. This communication system 1 can compensate for non-linear distortion in the reception signal in the counterpart station apparatus 1b.

### <Modified Examples of First to Third Embodiments (Including Modified Examples) of Present Disclosure>

In the coefficient updating units 50a, 50b according to the first to third embodiments (including modified examples) of the present disclosure, the frequency band of the signal output by the first calculation unit 503a is a frequency band that is three times the width of the frequency band of the ideal signal d at the symbol rate. Additionally, the frequency band of the signal output by the second calculation unit 503b is a frequency band that is five times the width of the frequency band of the ideal signal d at the symbol rate. For this reason, there is a possibility that the frequency band output by the harmonic calculation unit 503 will not fit inside the frequency band at the symbol rate. For example, the frequency band indicated in FIG. 4E may not fit inside the frequency band at the symbol rate.

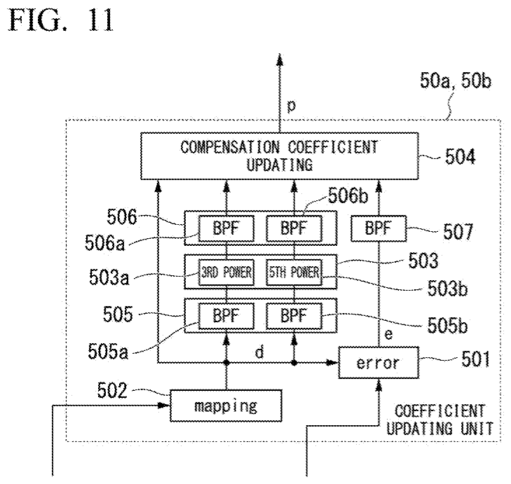

FIG. 11 is a diagram illustrating an example of the configuration of the coefficient updating units 50a, 50b according to the modified examples of the first to third embodiments (including modified examples) of the present disclosure. The coefficient updating units 50a, 50b according to the modified examples of the first to third embodiments (including modified examples) of the present disclosure are respectively provided with an error calculation unit 501, a mapping unit 502, a harmonic calculation unit 503, and a compensation coefficient updating unit 504, as illustrated in FIG. 11. Additionally, the coefficient updating units 50a, 50b according to the modified examples of the first to third embodiments (including modified examples) of the present disclosure are respectively further provided with a first filter unit 505, a second filter unit 506, and a third filter unit 507, as illustrated in FIG. 11.

The coefficient updating units 50a, 50b illustrated in FIG. 11 are provided with the first filter unit 505 between the mapping unit 502 and the harmonic calculation unit 503 in the coefficient updating unit 50a illustrated in FIG. 1. Additionally, the coefficient updating units 50a, 50b illustrated in FIG. 11 are provided with the second filter unit 506 between the harmonic calculation unit 503 and the compensation coefficient updating unit 504 in the coefficient updating unit 50a illustrated in FIG. 1. Additionally, the coefficient updating units 50a, 50b illustrated in FIG. 11 are provided with the third filter unit 507 between the error calculation unit 501 and the compensation coefficient updating unit 504 in the coefficient updating unit 50a illustrated in FIG. 1.

The first filter unit 505 is provided with BPFs (Band Pass Filters) 505a, 505b. The BPFs 505a, 505b are respectively set so as to pass signals in a frequency band obtained by dividing the frequency of the band at the symbol rate by the highest order number (in this example, the order number 5) in the harmonics that are to be processed by the harmonic calculation unit 503. The BPF 505a is a filter corresponding to the first calculation unit 503a. The BPF 505b is a filter corresponding to the second calculation unit 503b.

The second filter unit 506 is provided with BPFs (Band Pass Filters) 506a, 506b. The BPFs 506a, 506b are respectively set, for example, so as not to pass signals outside the frequency band at the symbol rate. The BPFs 506a, 506b are respectively set, for example, so as to pass signals in any frequency band between the frequency band passed by the BPFs 505a, 505b and the frequency band at the symbol rate. The BPF 506a is a filter corresponding to the first calculation unit 503a. The BPF 506b is a filter corresponding to the second calculation unit 503b.

The third filter unit 507 is a BPF. The third filter unit 507 is set, for example, to pass signals in the same frequency band as the BPFs 506a, 506b. The third filter unit 507 is a filter corresponding to the error calculation unit 501.

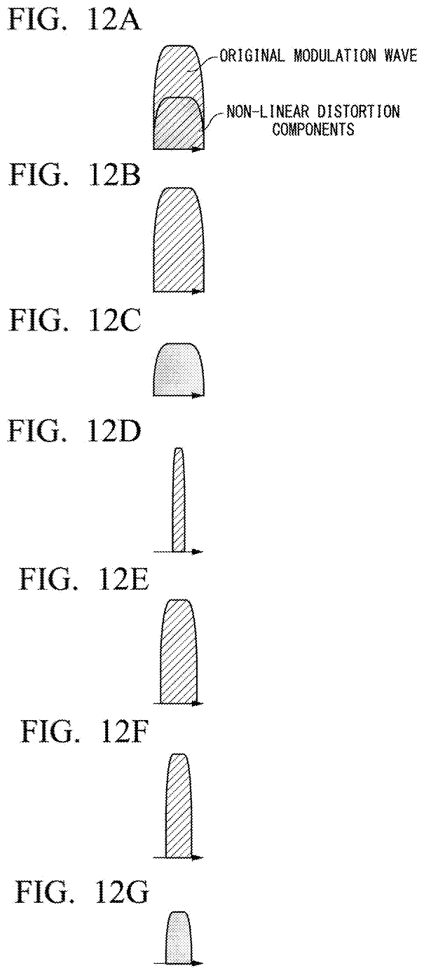

FIG. 12A to FIG. 12G are diagrams for explaining the processing in the coefficient updating units 50a, 50b according to the modified examples of the first to third embodiments (including modified examples) of the present disclosure. The horizontally oriented arrows in FIG. 12A to FIG. 12G represent the frequency band at the symbol rate.

FIG. 12A corresponds to FIG. 4B and indicates an image of the frequency band of the output signal from the clock recovery/equalizer 401. The frequency band of the signal indicated in FIG. 12A is equivalent to the frequency band at the symbol rate. FIG. 12B corresponds to FIG. 4C and indicates an image of the frequency band of the output signal (i.e., the ideal signal d) from the mapping unit 502. The frequency band of the signal indicated in FIG. 12B is equivalent to the frequency band at the symbol rate.

FIG. 12C corresponds to FIG. 4D and indicates an image of the frequency band of the output signal (i.e., the error signal e) from the error calculation unit 501. The frequency band of the signal indicated in FIG. 12C is equivalent to the frequency band at the symbol rate.

FIG. 12D indicates an image of the frequency band of the output signal from the BPF 505a of the first filter unit 505. The frequency band of the signal indicated in FIG. 12D is approximately one-fifth of the frequency band at the symbol rate.

FIG. 12E corresponds to FIG. 4E and indicates an image of the frequency band of the output signal from the first calculation unit 503a. As indicated in FIG. 12E, the output signal from the first calculation unit 503a fits within the frequency band at the symbol rate.

FIG. 12F indicates an image of the frequency band of the output signal from the BPF 506a of the second filter unit 506. The frequency band of the signal indicated in FIG. 12F is in an even narrower range than the frequency band of the output signal from the first calculation unit 503a indicated in FIG. 12F, and fits within the frequency band at the symbol rate.

FIG. 12G indicates an image of the frequency band of the output signal from the third filter unit 507, which is a BPF. The frequency band of the signal indicated in FIG. 12G is in an even narrower range than the frequency band of the output signal from the clock recovery/equalizer 401 indicated in FIG. 12B, and is equivalent to the frequency band indicated in FIG. 12F.

The coefficient updating units 50a, 50b according to the modified examples of the first to third embodiments (including the modified examples) of the present disclosure are provided with the first filter unit 505, the second filter unit 506, and the third filter unit 507, thereby allowing any signal in the coefficient updating units 50a, 50b to fit within the frequency band at the symbol rate.

In the communication system 1 above, the harmonics that are processed by the harmonic calculation unit 503 were explained to be the third-order harmonic and the fifth-order harmonic. However, in other embodiments of the present disclosure, the harmonics that are processed by the harmonic calculation unit 503 are not limited to the third-order harmonic and the fifth-order harmonic. For example, the harmonics that are processed by the harmonic calculation unit 503 may be n-th order harmonics (n being an integer equal to or greater than 2), and may be one or multiple harmonics.

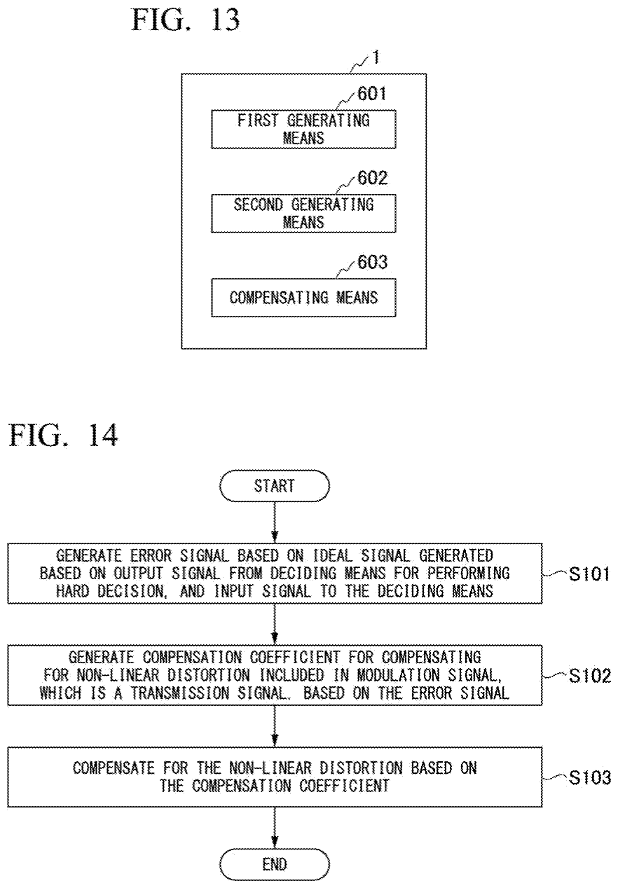

FIG. 13 is a diagram illustrating the minimum configuration of the communication system 1 according to an embodiment of the present disclosure. The communication system 1, as illustrated in FIG. 13, is provided with a first generating means 601, a second generating means 602, and a compensating means 603. The first generating means 601 generates an error signal based on an ideal signal generated based on an output signal from a deciding means for performing a hard decision, and an input signal to the deciding means. The second generating means 602 generates a compensation coefficient for compensating for non-linear distortion included in a modulation signal, which is a transmission signal, based on the error signal. The compensating means 603 compensates for the non-linear distortion based on the compensation coefficient. The first generating means 601 can be realized, for example, by using the functions of the error calculation unit 501 illustrated in FIG. 1, FIG. 7, and FIG. 9. The second generating means 602 can be realized, for example, by using the functions of the compensation coefficient updating unit 504 illustrated in FIG. 1, FIG. 7, and FIG. 9. The compensating means 603 can be realized, for example, by using the functions of the DPD compensation unit 101 illustrated in FIG. 1, the non-linear distortion compensation unit 403 illustrated in FIG. 10, etc.

FIG. 14 is a diagram indicating an example of the processing flow in the communication system 1 with the minimum configuration according to an embodiment of the present disclosure. Next, the processing in the communication system 1 with the minimum configuration according to an embodiment of the present disclosure will be explained with reference to FIG. 14.

The first generating means 601 generates an error signal based on an ideal signal generated based on an output signal from a deciding means for performing a hard decision, and an input signal to the deciding means (step S101). The second generating means 602 generates a compensation coefficient for compensating for non-linear distortion included in a modulation signal, which is a transmission signal, based on the error signal (step S102). The compensating means 603 compensates for the non-linear distortion based on the compensation coefficient (step S103).

The communication system 1 with the minimum configuration according to an embodiment of the present disclosure has been explained above. Due to this communication system 1, non-linear distortion included in the modulation signal, which is the transmission signal, can be compensated without directly using the input modulation signal to generate coefficients for compensating for the non-linear distortion.

Regarding the processes in the embodiment of the present disclosure, the order of the processes may be switched within the range in which appropriate processes are performed.

Although embodiments of the present disclosure have been explained, the communication system 1, the local station apparatus 1a, and the counterpart station apparatus 1b described above, as well as other control apparatuses, may be provided with internal computer systems. Furthermore, the steps in the processes described above may be stored, in the form of a program, on a computer-readable recording medium, and the processes described above may be performed by a computer reading out and executing this program. Specific examples of computers are indicated below.

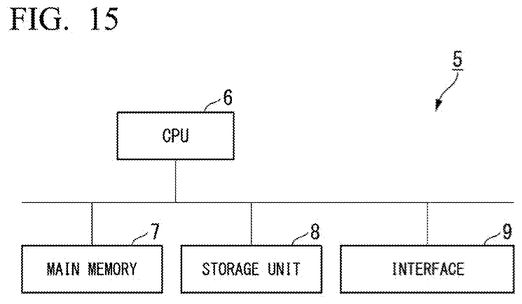

FIG. 15 is a schematic block diagram illustrating the configuration of a computer according to at least one embodiment. The computer 5 is provided with a CPU (Central Processing Unit) 6, a main memory 7, a storage unit 18, and an interface 9, as indicated in FIG. 15.

For example, the communication system 1, the local station apparatus 1a, and the counterpart station apparatus 1b described above, as well as other control apparatuses, are each implemented on the computer 5. Furthermore, the operations of the respective processing units mentioned above are stored in the storage unit 8 in the form of a program. The CPU 6 reads the program from the storage unit 8 and loads it in the main memory 7, and executes the processes described above in accordance with said program. Additionally, the CPU 6 secures storage areas corresponding to the respective storage units mentioned above in the main memory 7 in accordance with the program.

As examples of the storage unit 8, there are HDDs (Hard Disk Drives), SSDs (Solid-State Drives), magnetic disks, magneto-optic disks, CD-ROMs (Compact Disc Read-Only Memory), DVD-ROMs (Digital Versatile Disc Read-Only Memory), semiconductor memory, etc. The storage unit 8 may be internal media directly connected to a bus in the computer 5, or may be external media connected to the computer 5 by an interface 9 or a communication line. Additionally, in the case in which this program is distributed to the computer 5 by a communication line, the computer 5 to which the program has been distributed may load said program in the main memory 7 and execute the above-mentioned processes. In at least one embodiment, the storage unit 8 is a tangible storage medium that is non-transitory.

Additionally, the above-mentioned program may realize just some of the aforementioned functions. Furthermore, the above-mentioned program may be a so-called difference file (difference program) that can realize the aforementioned functions by being combined with a program already recorded in the computer system.

As mentioned above, communication technologies are used in various fields. There are cases in which non-linear distortion occurs due to non-linear characteristics of an amplifier in a communication system. When compensating for the non-linear distortion included in a modulation signal, which is a transmission signal, for example, pre-distortion compensation technology is used. In common pre-distortion compensation technology, an input modulation signal is defined to be an ideal signal, and coefficients for compensating for non-linear distortion are generated based on the differences between the modulation signal and a feedback signal. In this case, the timing must be adjusted between the input modulation signal and the feedback signal. Additionally, if the transmission rate and the reception rate differ, then rate conversion must also be performed. For this reason, technology is sought that can compensate for non-linear distortion included in a modulation signal, which is a transmission signal, without directly using the input modulation signal to generate the coefficients for compensating for the non-linear distortion.

According to the present disclosure, for example, according to the respective embodiments of the present disclosure, the non-linear distortion included in a modulation signal, which is a transmission signal, can be compensated without directly using the input modulation signal to generate the coefficients for compensating for the non-linear distortion.

Although a number of embodiments of the present disclosure have been explained, these embodiments are exemplary and do not limit the scope of the disclosure. Various additions, omissions, substitutions, and modifications can be made to these embodiments within a range not departing from the spirit of the disclosure.

While preferred embodiments of the disclosure have been described and illustrated above, it should be understood that these are exemplary of the disclosure and are not to be considered as limiting. Additions, omissions, substitutions, and other modifications can be made without departing from the spirit or scope of the present disclosure. Accordingly, the disclosure is not to be considered as being limited by the foregoing description, and is only limited by the scope of the appended claims.

The whole or part of the example embodiments disclosed above can be described as, but not limited to, the following supplementary notes.

### (Supplementary Note 1)

A communication system comprising:
first generating means for generating an error signal based on an ideal signal generated based on an output signal from a deciding means for performing a hard decision, and an input signal to the deciding means;
second generating means for generating a compensation coefficient for compensating for non-linear distortion included in a modulation signal, which is a transmission signal, based on the error signal; and compensating means for compensating for the non-linear distortion based on the compensation coefficient.

### (Supplementary Note 2)

The communication system according to Supplementary note 1, comprising
a first apparatus,
wherein
the first generating means, the second generating means, and the compensating means are provided in the first apparatus.

### (Supplementary Note 3)

The communication system according to Supplementary note 2, wherein the first apparatus is a local station apparatus that transmits the transmission signal or a counterpart station apparatus that receives the transmission signal.

### (Supplementary Note 4)

The communication system according to Supplementary note 1, comprising
a first apparatus, and
a second apparatus,
wherein
the compensating means is provided in the first apparatus, and
the first generating means and the second generating means are provided in the second apparatus.

### (Supplementary Note 5)

The communication system according to Supplementary note 4, wherein
the first apparatus is a local station apparatus that transmits the transmission signal, and
the second apparatus is a counterpart station apparatus that receives the transmission signal.

### (Supplementary Note 6)

The communication system according to any one of Supplementary note 1 to Supplementary note 5, comprising
third generating means for generating the ideal signal based on the output signal.

### (Supplementary Note 7)

The communication system according to any one of Supplementary note 1 to Supplementary note 6, comprising
calculating means for calculating an integer power of the ideal signal.

### (Supplementary Note 8)

The communication system according to any one of Supplementary note 1 to Supplementary note 7, comprising
filtering means for limiting a frequency band of the ideal signal.

### (Supplementary Note 9)

A processing method that involves:
generating an error signal based on an ideal signal generated based on an output signal from a deciding means for performing a hard decision, and an input signal to the deciding means;
generating a compensation coefficient for compensating for non-linear distortion included in a modulation signal, which is a transmission signal, based on the error signal; and
compensating for the non-linear distortion based on the compensation coefficient.

### (Supplementary Note 10)

A program for making a computer execute a process of:
generating an error signal based on an ideal signal generated based on an output signal from a deciding means for performing a hard decision, and an input signal to the deciding means;
generating a compensation coefficient for compensating for non-linear distortion included in a modulation signal, which is a transmission signal, based on the error signal; and
compensating for the non-linear distortion based on the compensation coefficient.

What is claimed is:

1. A communication system comprising:
first generator for generating an error signal based on an ideal signal generated based on an output signal from a decider for performing a hard decision, and an input signal to the decider;
second generator for generating a compensation coefficient for compensating for non-linear distortion included in a modulation signal, which is a transmission signal, based on the error signal; and
compensator for compensating for the non-linear distortion based on the compensation coefficient.

2. The communication system according to claim 1, comprising
a first apparatus,
wherein
the first generator, the second generator, and the compensator are provided in the first apparatus.

3. The communication system according to claim 2, wherein
the first apparatus is a local station apparatus that transmits the transmission signal or a counterpart station apparatus that receives the transmission signal.

4. The communication system according to claim 1, comprising
a first apparatus, and
a second apparatus,
wherein
the compensator is provided in the first apparatus, and
the first generator and the second generator are provided in the second apparatus.

5. The communication system according to claim 4, wherein
the first apparatus is a local station apparatus that transmits the transmission signal, and
the second apparatus is a counterpart station apparatus that receives the transmission signal.

6. The communication system according to claim 1, comprising
third generator for generating the ideal signal based on the output signal.

7. The communication system according to claim 1, comprising
calculator for calculating an integer power of the ideal signal.

8. The communication system according to claim 1, comprising
filter for limiting a frequency band of the ideal signal.

9. A processing method comprising:
generating an error signal based on an ideal signal generated based on an output signal from a decider for performing a hard decision, and an input signal to the decider;
generating a compensation coefficient for compensating for non-linear distortion included in a modulation signal, which is a transmission signal, based on the error signal; and
compensating for the non-linear distortion based on the compensation coefficient.

10. A non-transitory computer-readable storage medium that stores a program for making a computer execute a process, the process comprising:
generating an error signal based on an ideal signal generated based on an output signal from a decider for performing a hard decision, and an input signal to the decider;
generating a compensation coefficient for compensating for non-linear distortion included in a modulation signal, which is a transmission signal, based on the error signal; and
compensating for the non-linear distortion based on the compensation coefficient.
